(19) United States
(12) Patent Application Publication
(10) Pub. No.: US 2026/0261104 A1
(43) Pub. Date: Sep. 3, 2026

(54) AN ELECTRICAL COMPONENT ASSEMBLY

(71) Applicant: ELIGENT AS, Oslo (NO)

(72) Inventor: Tarjei JESPERSEN, Grimstad (NO)

(21) Appl. No.: 18/871,460

(22) PCT Filed: Aug. 4, 2023
(86) PCT No.: PCT/NO2023/060030

§ 371 Date: Dec. 3, 2024

(30) Foreign Application Priority Data
Sep. 23, 2022 (NO) 20221009

(51) Int. Cl. H02G 3/08

(52) U.S. Cl. CPC H02G 3/08

(57) ABSTRACT

An electrical component assembly comprises a mounting unit (2; 62), a mounting device (7; 67), an electrical component (1; 61), one or more fasteners (6; 66), and an outer element (4; 64), wherein said one or more fasteners (6; 66) are arranged in the outer element (4; 64). The mounting unit (2; 62) is configured for receiving the mounting device (7; 67) and the mounting device (7) is configured for receiving the electrical component (1). The position of the mounting device (7; 67) relative to the mounting unit (2; 62) is adjustable, the housing (2; 62) and/or the mounting device (7) comprises one or more fastener devices (15, 10, 11, 12; 93, 94) configured for releasable connection to said one or more fasteners (6; 66), and the fastener devices (15, 10, 11, 12; 93, 94) and the fasteners (6; 66) are operable to be forced towards each other, whereby the outer element (4; 64) and the mounting device (7; 67) are releasably fixated to the mounting unit (2; 62).

### TECHNICAL FIELD OF THE INVENTION

The invention relates to an electrical component assembly as defined by claim 1, and to methods of installation as defined by claims 13 and 14.

### BACKGROUND OF THE INVENTION

The prior art includes U.S. Pat. No. 6,166,329, which describes an electrical device assembly for mounting behind a wall surface. The assembly includes an electrical device mechanically attached to a mounting plate, and a rigid protector extending over the device to protect the device during wall construction. The hard metal protector enables an uninterrupted sheet of drywall or other wall facing material, hung in place over the device, to be cut through with a saw or router without risk of damaging the device by incidental contact with the cutting blade. To facilitate field installation of wall-mounted electrical devices, the assembly may be provided as a pre-wired assembly in which the device is mounted and wired within a standard junction box from which wires extend in a wire conduit. The assembly is mounted directly to an internal wall support prior to the installation of the wall's covering material (e.g. a drywall or panel). A shortcoming of the prior art is the inability to accommodate wall panels of different thicknesses.

### SUMMARY OF THE INVENTION

The invention is set forth and characterized in the main claim, while the dependent claims describe other characteristics of the invention.

It is thus provided an electrical component assembly, comprising a mounting unit, a mounting device, an electrical component, one or more fasteners, and an outer element, wherein said one or more fasteners are arranged in the outer element, characterized in that
the mounting unit is configured for receiving the mounting device and the mounting device is configured for receiving the electrical component (1);
the position of the mounting device relative to the mounting unit is adjustable;
the housing and/or the mounting device comprises one or more fastener devices configured for releasable connection to said one or more fasteners; and
the fastener devices and the fasteners are operable to be forced towards each other, whereby the outer element and the mounting device are releasably fixated to the mounting unit.

In one embodiment,
the mounting unit comprises a portion which is shaped and configured for receiving the mounting device and wherein the portion comprises a connection structure arranged in the inside;
the electrical component comprises an outward profile which corresponds to the mounting device outer shape; and
said one or more fasteners are configured for securing the outer element to the mounting device.

In one embodiment, the mounting device comprises a plurality of connection devices that comprise locking members that are configured for releasable interlocking with corresponding potions of the connection structure in the portion. The mounting device may comprise recesses and the connection devices may be movably arranged in respective recesses.

In one embodiment, the mounting device comprises one or more receptacle for a corresponding fastener, and the one or more receptacle is arranged in the vicinity of a corresponding connection device, whereby the connection device is forced into a locking engagement with the portion when a fastener is engaged with the receptacle.

In one embodiment, the outward profile, the inner shape of the portion, and the outer shape of the mounting device, have complementary shapes.

In one embodiment, the mounting unit comprises one or more fastener devices configured for releasable connection to said one or more fasteners; and said one or more fastener device comprises a channel arranged in the mounting unit and a adjustment screw which is shaped and configured for releasable connection to a respective channel, and each adjustment screw comprises an interface portion configured and arranged for receiving a portion of a respective fastener.

In one embodiment, the one or more fastener comprises a threaded screw and the threaded portion of the fastener screw extends through the outer element and is configured for threaded engagement with said interface portion.

In one embodiment, the interface portion comprises an internal bore configured for receiving said threaded portion of a corresponding fastener screw.

In one embodiment, the mounting device comprises a chassis which is shaped and configured for being inserted into a cavity in the mounting unit via a portion and the chassis is shaped and configured for receiving the electrical component. In one embodiment, the outer element is a cover having receptacles.

In one embodiment, the assembly comprises a protective cover which is configured to be removably arranged on the mounting device on a side of the mounting device that faces away from the mounting unit.

It is also provided a method of installing the invented electrical component assembly of the first embodiment; characterized by:
a) arranging the electrical component in the mounting device and arranging the mounting device in the mounting unit;
b) engaging one or more fastener with a corresponding one or more fastener device; and
c) operating said one or more fastener to releasably fixate the outer element, the mounting device, and the electrical component to each other and to the mounting unit.

It is also provided a method of installing the invented electrical component assembly of the second embodiment; characterized by:
a) arranging the electrical component in the mounting unit and arranging the mounting device in the mounting unit such that the electrical component at least partly is received in the mounting device;
b) engaging one or more fastener with a corresponding one or more fastener device; and
c) operating said one or more fastener to releasably fixate the outer element, the mounting device, and the electrical component to each other and to the mounting unit.

In the method of installing the invented electrical component assembly of the second embodiment;
step b) comprises inserting the outer element into the mounting device such that one or more fastener mates with the bore in a respective adjustment screw, and
step c) comprises rotating the fastener until it firmly engages with the bore, and a continued rotation of the fastener also will rotate the adjustment screw.

### BRIEF DESCRIPTION OF THE DRAWINGS

These and other characteristics of the invention will become clear from the following description of embodiments of the invention, given as non-restrictive examples, with reference to the attached schematic drawings, wherein:

FIG. 1 is a perspective exploded view of a first embodiment of the electrical component assembly according to the invention;

FIG. 2 is a perspective view of an embodiment of the mounting device according to the first embodiment of the invention;

FIG. 3 is a sectional-perspective view illustrating the mounting device according to the first embodiment of the invention installed inside a mounting box;

FIG. 4 is an enlarged view of the area marked “A” in FIG. 3;

FIG. 5 is a front view (upper drawing) and a sectional view along section A-A (lower drawing) of the first embodiment of the assembly according to the invention, installed in a wall of a first configuration;

FIG. 6 is an enlarged view of the area marked “B” in FIG. 5;

FIG. 7 corresponds to FIG. 5, but illustrates the assembly according to the invention installed in a wall of a second configuration;

FIG. 8 is an enlarged view of the area marked “C” in FIG. 7;

FIG. 9 is a sectional-perspective view illustrating the assembly according to the first embodiment of the invention installed behind a wall element, also comprising a cover plate covering the electrical component at the hole in the wall element;

FIG. 10 is a sectional-perspective view illustrating the assembly according to the first embodiment of the invention installed behind a wall element, and the electrical device is an electrical switch;

FIG. 11 is a perspective exploded view of a second embodiment of the electrical component assembly according to the invention;

FIG. 12 is a sectional drawing of the view of FIG. 11;

FIG. 13 is another exploded view of the embodiment illustrated in FIG. 11; FIG. 14 is a sectional drawing of the view of FIG. 13;

FIG. 15 is a perspective view illustrating an assembly sequence of the embodiment illustrated in FIG. 11;

FIG. 16 is a sectional drawing of the view of FIG. 15;

FIG. 17 is a partly sectional perspective view corresponding to FIG. 16; and

FIG. 18 corresponds to FIG. 17 and illustrates an installation sequence.

### DETAILED DESCRIPTION OF EMBODIMENTS OF THE INVENTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

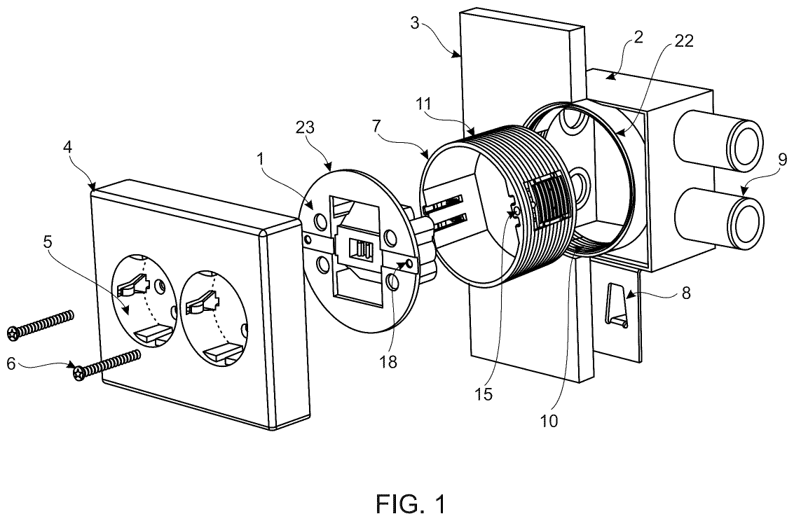

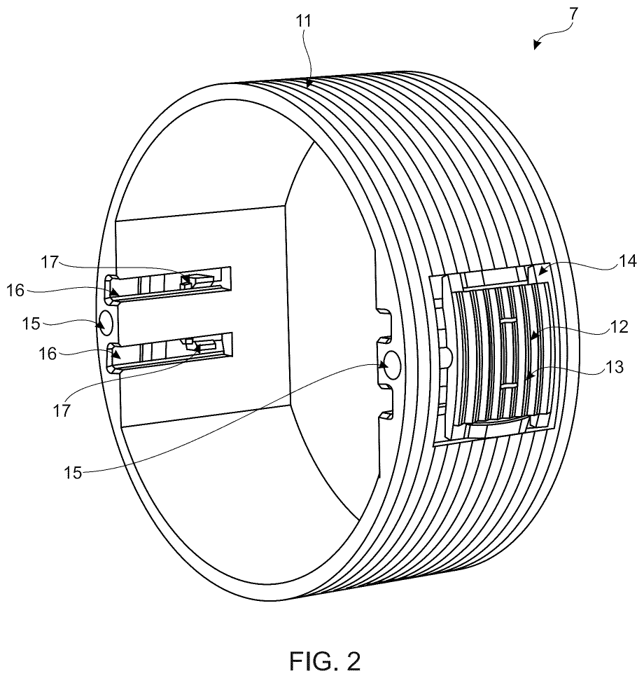

The electrical component assembly according to the invention comprises in a first embodiment a mounting unit 2, a mounting device 7, an electrical component 1, and an outer element 4. In the embodiment illustrated in FIG. 1, the mounting unit 2 is a housing configured for receiving the mounting device 7 and the electrical component 1. The housing 2 is configured for connection to a wall structure (e.g. a stand or beam; not shown) in a manner known in the art, for example via a bracket 8, and comprises one or more cable conduit receptacles 9. The electrical component 1 is furnished with holes 18 that are aligned with corresponding holes in the outer element 4 and with corresponding receptacles 15 in the mounting device 7. The cover 4 is connectable to the mounting device 7 by fasteners 6, in the illustrated embodiment in the form of threaded screws, in a manner which will be explained below. The mounting device 7 is configured for receiving the electrical component 1. Connecting the outer element 4 to the mounting device 7 will therefore also connect the electrical component 1 to the mounting device 7.

In the embodiment illustrated in FIG. 1, the electrical component 1 is a duplex electrical outlet, and the cover 4 comprises two corresponding receptacles 5. The invention shall not be limited to the embodiment illustrated in FIG. 1, inasmuch as the electrical component may be any electrical component suitable for installation in the housing 2; for example a simplex electrical outlet with a cover having a single receptacle, a thermostat, or an electrical switch. The latter example is illustrated in FIG. 10, showing the electrical component as an electrical switch 1′ installed in a housing 2, and the outer element being a switch toggle 4′.

Referring again to FIG. 1, the mounting unit 2 comprises a portion 22 which is shaped and configured for receiving the mounting device 7. The portion 22 comprises a connection structure 10, arranged in the inside and comprising grooves (ridges and valleys), the purpose and function of which will be described below. The electrical component 1 comprises an outward profile 23 which corresponds to the mounting device 7 outer shape. In the illustrated embodiment, the outward profile 23, the inner shape of the portion 22, and the outer shape of the mounting device 7 are circular, but the invention shall not be limited to such geometries as long as the geometries are complementary.

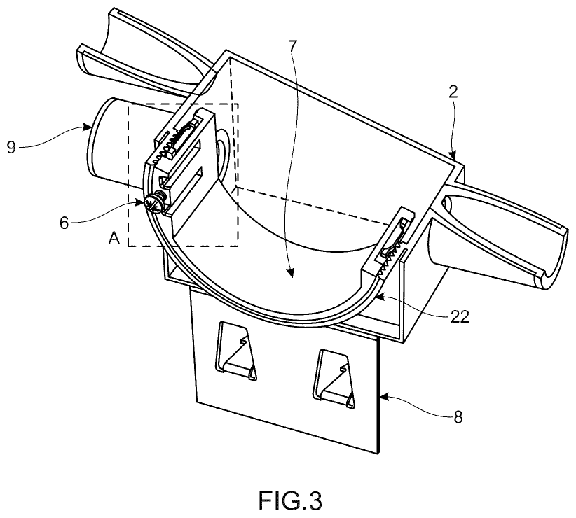

Referring now to FIG. 2, the mounting device 7 comprises a holding structure 11, here in the form of grooves (ridges and valleys) arranged on the outside of the mounting device 7 and configured for releasable interlocking connection with the connection structure (grooves) 10 in the portion 22. The holding structure 11 preferably comprises flexible ridges, allowing the mounting device 7 to be moved relative to the portion 22 in the mounting unit 2.

The mounting device 7 also comprises a plurality of connection devices 12 that in the illustrated embodiment are arranged in respective recesses 17 in the mounting device 7 outer surface. The connection devices 12 comprise locking members 13, here grooves (ridges and valleys), that are configured for releasable interlocking with corresponding portions of the connection structure (i.e. grooves) 10 in the portion 22. The connection devices 12 are movably connected to the mounting device 7 in a manner per se known in the art, for example via lugs 17 extending though corresponding slits 16 in the mounting device 7.

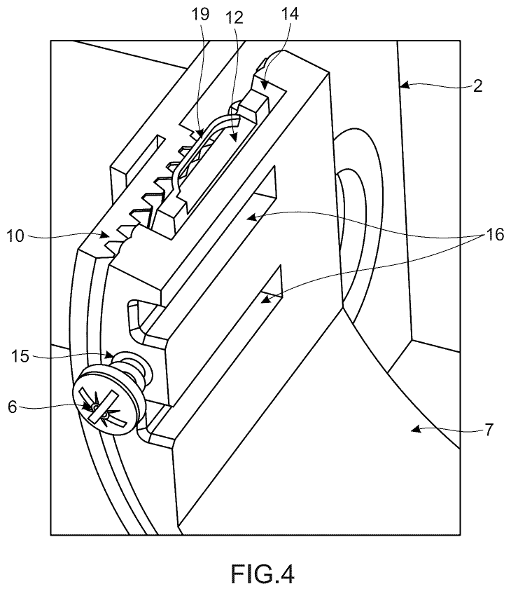

Referring additionally to FIG. 3 and FIG. 4, the connection devices 12 are arranged in the vicinity of the above-mentioned receptacles 15, and each comprise a spring member 19 that abuts against the connection structure 10 and thus contributes to pressing the connection device 12 into its recess 14. The mounting device 7 may thus be moved back and forth in the portion 22. However, when the above-mentioned fastener (screw) 6 is inserted into its respective receptacle 15, the spring force is overcome and the connection device 12 is forced outwards (by the fastener 6) such that the locking members (external grooves) 13 interlock with corresponding portions of the connection structure (grooves) 10 portion 22 of the mounting unit 2. The mounting device 7 is thus firmly locked to the mounting unit 2 as long as the fasteners 6 are in place. Referring again to FIG. 1, this implies that the electrical component 1 also is firmly locked to the mounting unit 2 when the fasteners 6 are in place as described. The electrical component 1 is being clamped between the outer element 4 and the mounting device 7 by virtue of the fasteners extending through the holes 18. The outward profile 23 of the electrical component corresponds to the mounting device 7 outer shape, and the device 7 outer shape corresponds to the inner shape of the portion 22. In the illustrated embodiment, the outward profile 23, the portion 22 inner shape and the outer shape of the mounting device 7 are circular, but the invention shall not be limited to such geometries as long as the geometries are complementary and allow an assembly as illustrated in FIG. 1.

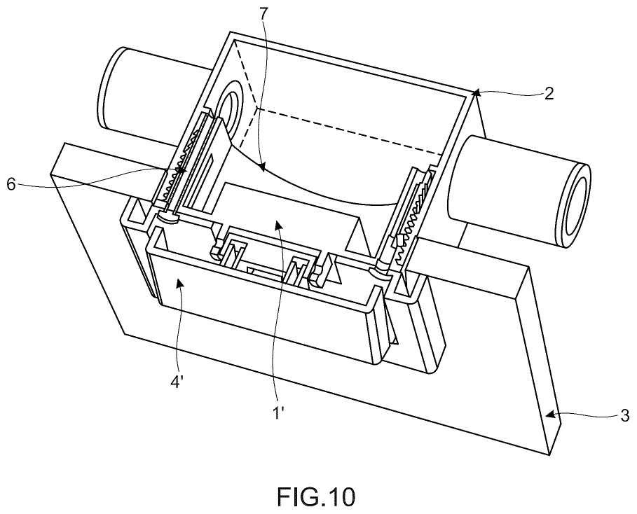

When installing the invented assembly, the mounting unit 2 is initially connected to a building element (e.g. a stand in a wall structure or a beam; not shown) in a manner known in the art, for example via the bracket 8. At this stage, the electrical component 1 and the mounting device 7 may be arranged inside the mounting unit 2 and electric cables (not shown) may be connected to the electrical component 1. The cables extend through the cable conduit receptacles 9 and into cable conduits (not show) in a manner known in the art. Referring to FIG. 9, a temporary cover plate 21 is placed in front of the electrical component 1. The temporary cover plate 21 keeps the mounting device 7 and the electrical component 1 in place, and protects the electrical component.

A covering element 3 (e.g. panel, drywall, plasterboard) is subsequently connected to the building element and furnished with a hole that corresponds to the outer shape of the portion 22 of the mounting unit (see also FIG. 1). When this covering element 3 is in place, the temporary cover plate 21 may be removed and the outer element 4 may be connected to the mounting device 7 as described above.

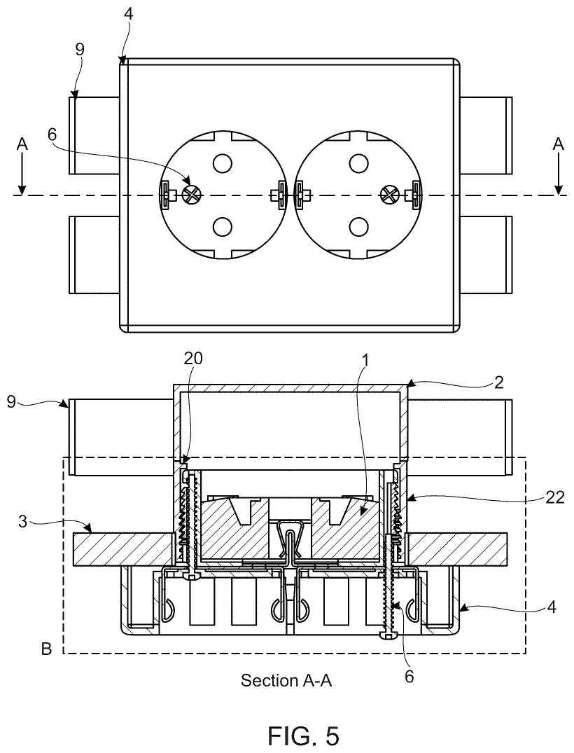

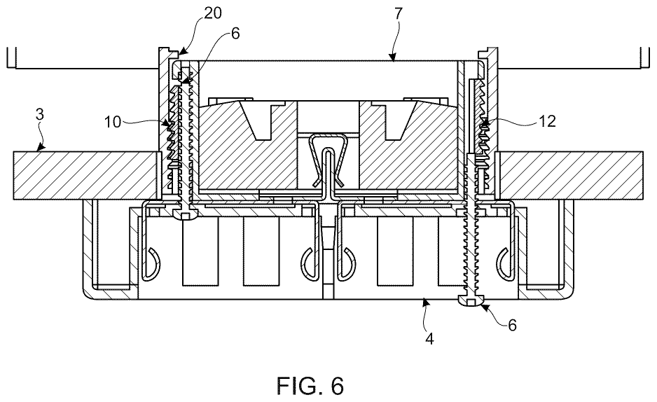

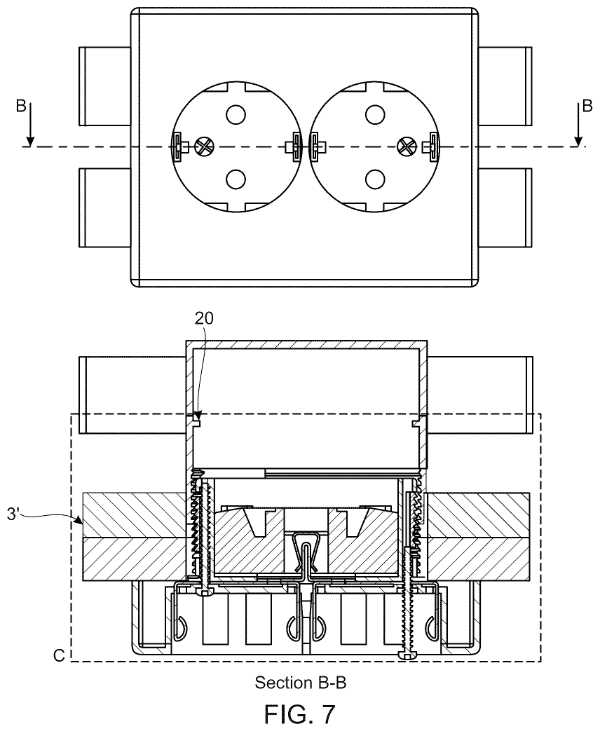

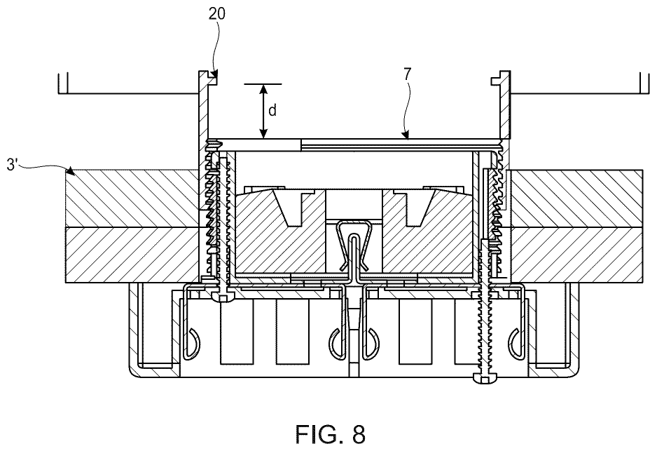

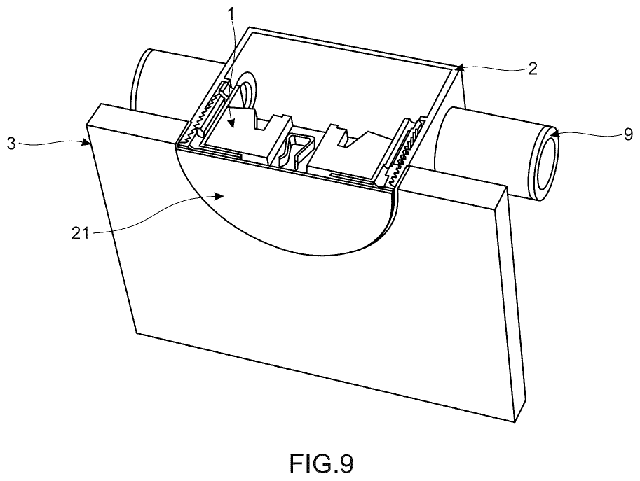

FIGS. 5 and 6 illustrate the invented assembly installed behind a covering element 3, and the portion 22 extending through the hole in the covering element. FIGS. 7 and 8 illustrate a similar installation configuration, but with a difference being that the covering element 3′ in FIGS. 7 and 8 is thicker than the covering element 3 in FIGS. 5 and 6. The invented assembly can accommodate such different thicknesses because the mounting device 7 is slidably arranged in the mounting unit 2, more specifically in the portion 22, as described above. In FIGS. 5 and 6, the mounting device 7 is at a maximum backward position, abutting against a stop member 20, whereas the mounting device 7 is at a maximum forward position in FIGS. 7 and 8, at a distance d away from the stop member 20. It will be understood that the mounting device 7 may be connected to the portion 22 at any intermediate position, by means of the features described above.

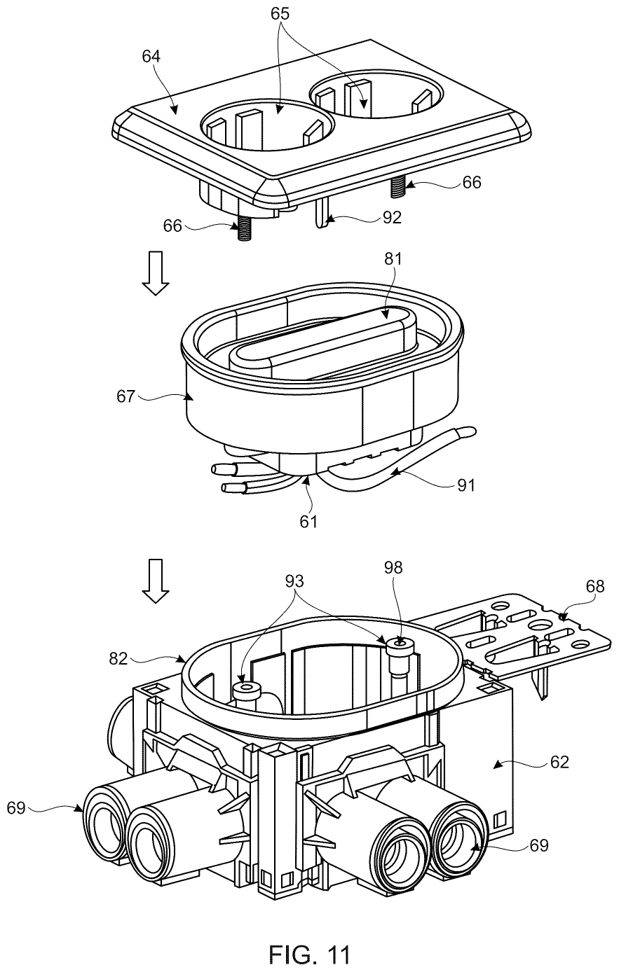

A second embodiment of the invented electrical component assembly is described in the following, with reference to FIGS. 11-18.

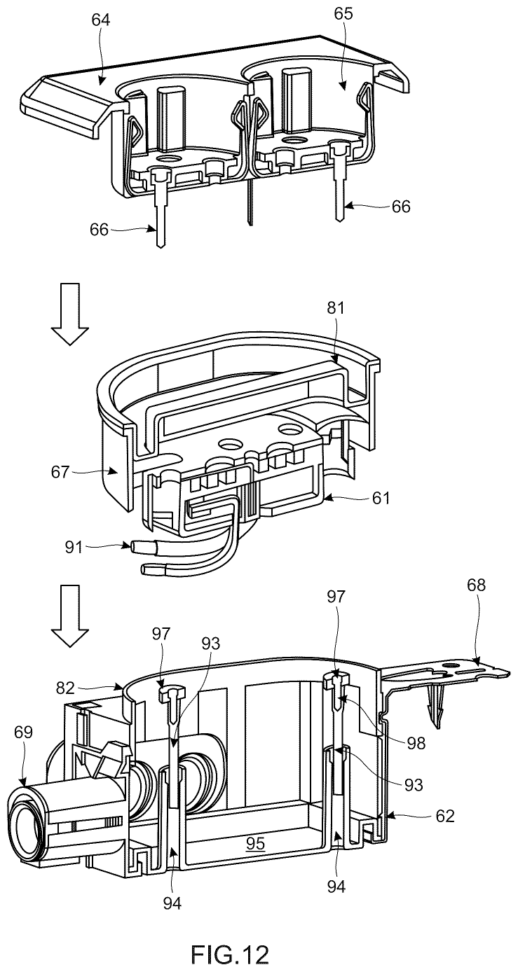

Referring initially to FIGS. 11 and 12, the electrical component assembly according to the invention comprises in the second embodiment a mounting unit in the form of a housing 62 which is configured for connection to a wall structure (e.g., a stand or beam; not shown) in a manner known in the art, for example via a bracket 68, and comprises one or more cable conduit receptacles 69.

A mounting device in the form of a chassis 67 is shaped and configured for being inserted into a cavity 95 in the housing 62 via an opening 82 which is shaped and configured for receiving the chassis 67. The chassis 67 is shaped and configured for receiving an electrical component 61—in the illustrated embodiment an electrical outlet. Reference number 91 denotes electrical cables that are connected to the electrical component and reference number 92 denotes an earthing connector. An outer element, in the form of a cover 64 having receptacles 65 and fasteners in the form of screws 66, is configured for connection to the housing 62 in a manner which is described below. Reference number 81 denotes a temporary protective cover, or dust cover, which may be placed on the chassis 67 in order to protect the electrical component 61 prior to final installation of the complete electrical component assembly.

A pair of fastener screws 66 are arranged in the cover 64 in a manner which per se is known in the art and e ach screw extends below the cover as shown in FIGS. 11 and 12. A pair of channels 94 are arranged in the housing 62 and corresponding adjustment screws 93 are shaped and configured for releasable connection to respective channels 94. Each adjustment screw 93 comprises an interface portion 97 configured and arranged for receiving a portion of a respective fastener screw. In the illustrated embodiment, the interface portion 97 comprises an internal, preferably threaded, bore 98 configured for receiving a threaded end of a corresponding fastener screw. The invention shall not be limited to this quantity, but may comprise fewer or more fastener screws, channels and adjustment screws.

When installing the invented assembly, the mounting unit 62 is initially connected to a building element (e.g., a stand in a wall structure or a beam; not shown) in a manner known in the art, for example via the bracket 68. At this stage, the electrical component 61 and the mounting device 67 are arranged inside the mounting unit 62 and electric cables 91 may be connected to the electrical component 61. The cables extend through the cable conduit receptacles 69 and into cable conduits (not show). The temporary cover plate 81 is placed in front of the electrical component 61, and serves to protect the electrical component.

A covering element (e.g., panel, drywall, plasterboard, not shown) is subsequently connected to the building element and furnished with a hole that corresponds to the outer shape of the portion 82 of the mounting unit. When this covering element is in place, the temporary cover plate 81 may be removed and the outer element 64 may be connected to the mounting device 67 as described above.

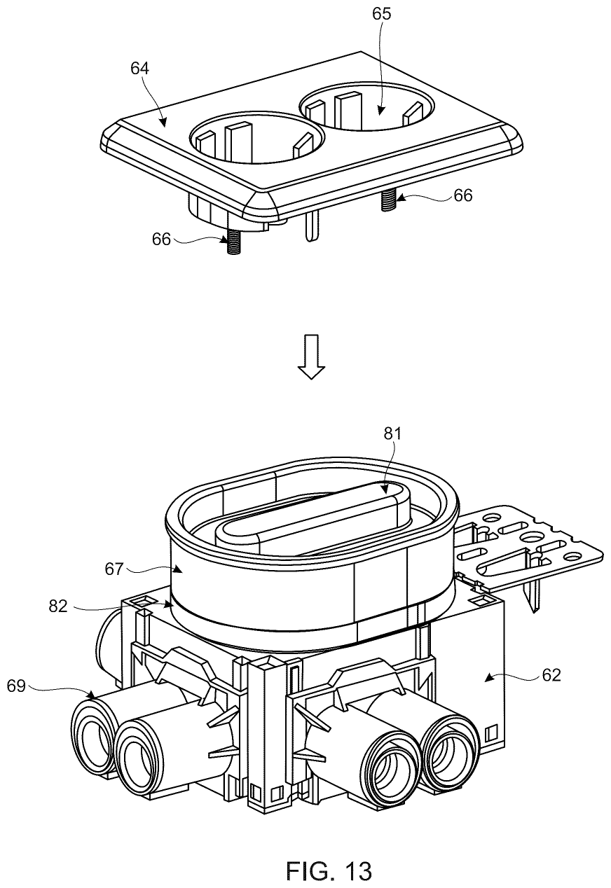

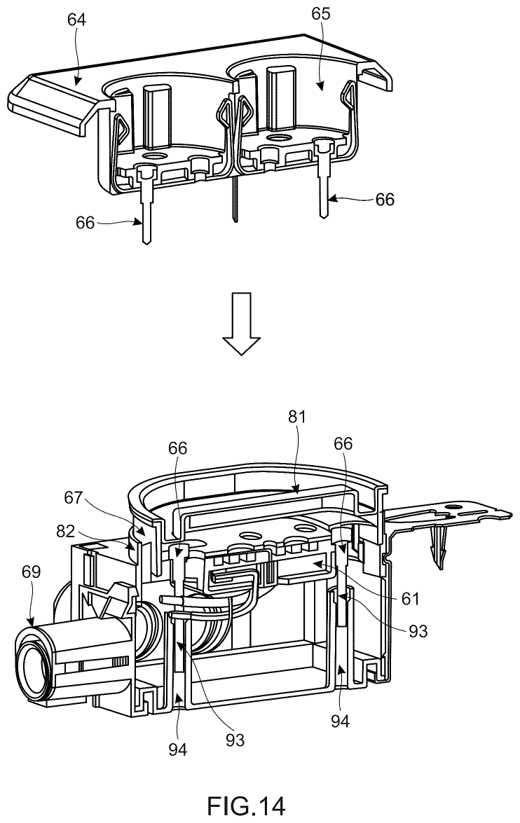

FIGS. 13 and 14 illustrate the electrical component assembly in an intermediate installation stage. As seen in the lower portion of FIGS. 13 and 14, the electrical component 61 has been arranged in the cavity inside the housing 62 and electrical cables 91 have been connected to the electrical component. The adjustment screws 93 are in place in respective channels 94 and the chassis (mounting device) 67, with the cover 81, has been partly inserted into the housing portion 82. Although not illustrated, the housing 62 has been connected to a support structure (not shown) and this part of the assembly may remain in this intermediate installation stage until it is time to install the outer element 64 (the upper portion of FIGS. 13 and 14), e.g., when the wall structure has been completed.

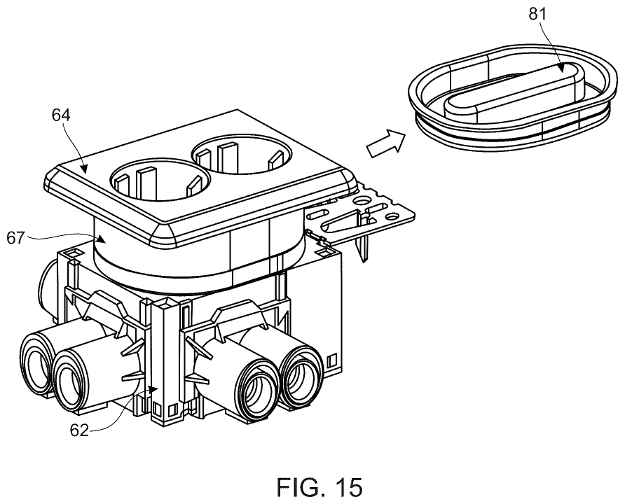

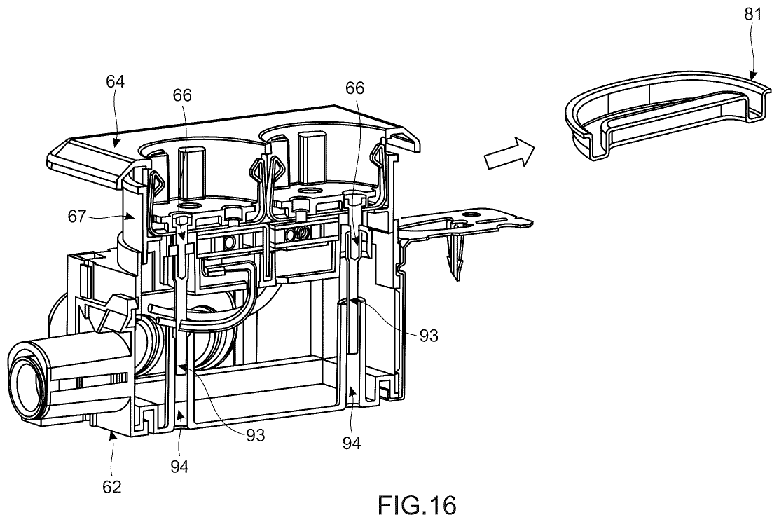

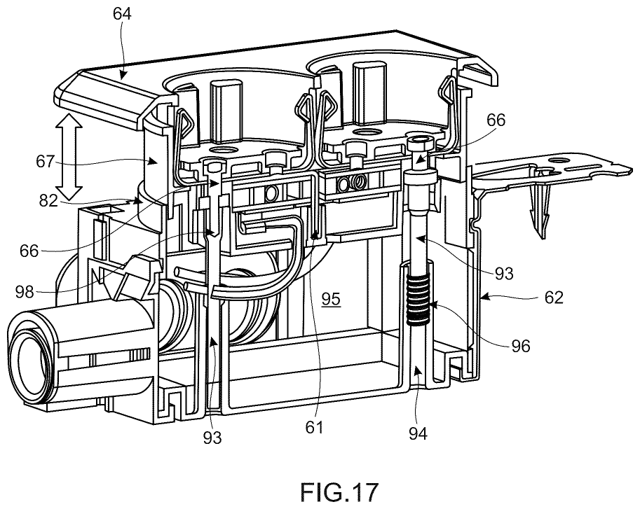

FIGS. 15 and 16 illustrate a further installation step from that illustrated in FIGS. 13 and 14. The temporary cover 81 has been removed, and the outer element 64 has been inserted into the chassis 67. At this stage, the fastener screws 66 have mated with the interface portion 97 on respective adjustment screws 93. This is also illustrated in FIG. 17. The outer element 64 may have been inserted into the chassis until it bears against a wall plate (not shown) surrounding the housing portion 82 and chassis 67.

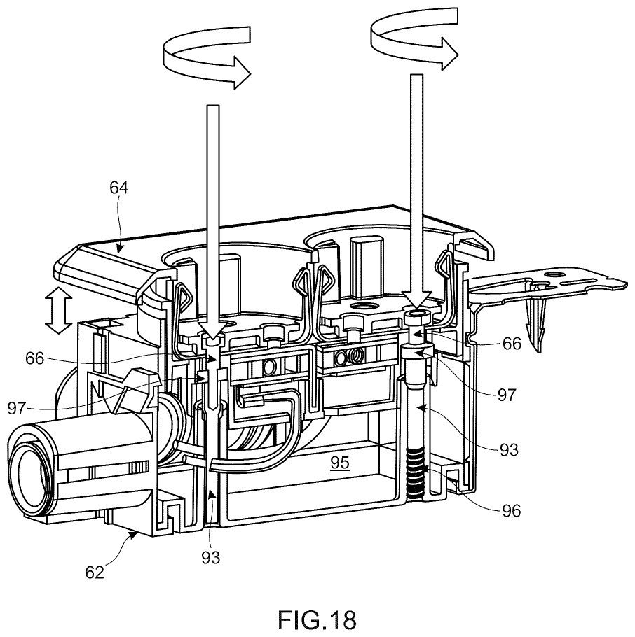

At this stage, rotating the fastener screws 66 will cause the threaded end of the fastener screws to engage with the interface portion 97 on the respective adjustment screw 93. In the illustrated embodiment, the interface portion 97 comprises a bore 98 that extends a distance inside the adjustment screw. The bore 98 may comprise threads that are complementary with the threaded end of the fastener screws, or other structures or materials that interact with the fastener screws. Therefore, when the fastener screw has reached the bottom of the interface portion (i.e., the internal, coaxial bore 98), a continued rotation of the fastener screw will cause the adjustment screw 93 to rotate inside the channel 94. A threaded portion 96 on the adjustment screw 93 will cause the latter to advance in the channel 94 and thus pull the outer element 64 and the electrical component 61 further into the cavity 94, as indicated by the arrows in FIGS. 17 and 18.

The outer element may thus be moved until it bears against a wall plate and thus accommodate the wall plate thickness.

In the embodiment illustrated in FIGS. 11-18, the electrical component 91 is a duplex electrical outlet, and the cover 64 comprises two corresponding receptacles 65. But the invention shall not be limited to this type, inasmuch as the electrical component may be any electrical component suitable for installation in the housing 62; for example a simplex electrical outlet with a cover having a single receptacle, a thermostat, or an electrical switch.

The invented electrical component assembly can accommodate different wall plate thicknesses because the chassis (mounting device) 67 is slidably arranged in the mounting unit 62, more specifically in the portion 82, as described above.

1. An electrical component assembly, comprising:
a mounting unit,
a mounting device,
an electrical component,
one or more fasteners, and
an outer element,
wherein said one or more fasteners are arranged in the outer element, and wherein:
the mounting unit is configured for receiving the mounting device and the mounting device is configured for receiving the electrical component;
the position of the mounting device relative to the mounting unit is adjustable;
the mounting unit or the mounting device comprises one or more fastener devices configured for releasable connection to said one or more fasteners; and
the fastener devices and the fasteners are operable to be forced towards each other, whereby the outer element and the mounting device are releasably fixated to the mounting unit.

2. The assembly of claim 1, wherein:
the mounting unit comprises a portion shaped and configured for receiving the mounting device and wherein the portion comprises a connection structure arranged in the inside;
the electrical component comprises an outward profile which corresponds to the mounting device outer shape; and
said one or more fasteners are configured for securing the outer element to the mounting device.

3. The assembly of claim 1, wherein the mounting device comprises a plurality of connection devices that comprise locking members that are configured for releasable interlocking with corresponding portions of the connection structure in the portion.

4. The assembly of claim 3, wherein the mounting device comprises recesses and the connection devices are movably arranged in respective recesses.

5. The assembly of claim 3, wherein the mounting device comprises one or more receptacle for a corresponding fastener, and the one or more receptacle is arranged in the vicinity of a corresponding connection device, whereby the connection device is forced into a locking engagement with the portion when a fastener is engaged with the receptacle.

6. The assembly of claim 1, wherein the outward profile, the inner shape of the portion, and the outer shape of the mounting device have complementary shapes.

7. The assembly of claim 1, wherein the mounting unit comprises one or more fastener devices configured for releasable connection to said one or more fasteners; and said one or more fastener device comprises a channel arranged in the mounting unit and a adjustment screw which is shaped and configured for releasable connection to a respective channel, and each adjustment screw comprises an interface portion configured and arranged for receiving a portion of a respective fastener.

8. The assembly of claim 7, wherein the one or more fastener comprises a threaded screw and the threaded portion of the fastener screw extends through the outer element and is configured for threaded engagement with said interface portion.

9. The assembly of claim 7, wherein the interface portion comprises an internal bore configured for receiving said threaded portion of a corresponding fastener screw.

10. The assembly of claim 7, wherein the mounting device comprises a chassis which is shaped and configured for being inserted into a cavity in the mounting unit via a portion and the chassis is shaped and configured for receiving the electrical component.

11. The assembly of claim 7, wherein the outer element is a cover having receptacles.

12. The assembly of claim 7, further comprising a protective cover which is configured to be removably arranged on the mounting device on a side of the mounting device that faces away from the mounting unit.

13. A method of installing the electrical component assembly of claim 1, the method comprising:
a) arranging the electrical component in the mounting device and arranging the mounting device in the mounting unit;
b) engaging one or more fastener with a corresponding one or more fastener device; and
c) operating said one or more fastener to releasably fixate the outer element, the mounting device, and the electrical component to each other and to the mounting unit.

14. A method of installing the electrical component assembly of claim 9, the method comprising:
a) arranging the electrical component in the mounting unit and arranging the mounting device in the mounting unit such that the electrical component at least partly is received in the mounting device;
b) engaging one or more fastener with a corresponding one or more fastener device; and
c) operating said one or more fastener to releasably fixate the outer element, the mounting device, and the electrical component to each other and to the mounting unit.

15. The method of claim 14, wherein:
step b) comprises inserting the outer element into the mounting device such that one or more fastener mates with the bore in a respective adjustment screw, and
step c) comprises rotating the fastener until it firmly engages with the bore, and a continued rotation of the fastener also will rotate the adjustment screw.
